(19) United States
(12) Patent Application Publication
(10) Pub. No.: US 2012/0174718 A1
(43) Pub. Date: Jul. 12, 2012

(54) Novel Wrenches

(76) Inventor: Ami James, Miami Beach, FL (US)

(21) Appl. No.: 13/423,979

(22) Filed: Mar. 19, 2012

Related U.S. Application Data
(63) Continuation-in-part of application No. 12/470,324, filed on May 21, 2009, now Pat. No. 8,136,427.

(51) Int. Cl. B25B 23/16; B25B 13/48; B25B 13/08; B25B 13/00; B25B 13/06

(52) U.S. Cl. 81/467; 81/177.1; 81/121.1; 81/129; 81/176.1; 81/124.2; 81/119

(57) ABSTRACT

A wrench and wrench kit whereby a single connected unit is releasably attached and allows a user to access separate wrench handles from the detachment and further where said wrench handles are provided as a kit wherein attached handles have identical size wrench heads.

### INDEX TO RELATED APPLICATIONS

This application is a continuation-in-part of U.S. patent application Ser. No. 12/470,324 filed May 21, 2009 the disclosure of which is incorporated herein by reference in its entirety.

### FIELD OF THE INVENTION

The invention relates to hand tools that can be used in a variety of projects. Specifically, the invention relates to wrenches having two heads that are useful for repairing many different types of objects. The objects include motorcycles, automobiles, small engines, and appliances. These wrenches may also have utility in home repair and improvement.

### BACKGROUND OF THE INVENTION

Combination wrenches, or those wrenches that have more than one working component are known in the tool art. Wrenches of these types can have two wrench heads, or a wrench head and another tool component. For example, U.S. Pat. No. 7,143,669 is a combination of a wrench and a drive member. U.S. Pat. No. 7,093,519 discloses a three-in-one wrench that has a structured ratchet wrench in the center of the wrench body, a socket wrench with opening jaws on one end of the wrench body, and an adjustable mortise-tenon pivotal wrench on the other end. U.S. Pat. No. 6,886,430 is a third combination ratchet and breaker bar wrench. U.S. Pat. No. 6,286,398 is also a combination wrench. Here the wrench heads will pivot if required. Yet another combination wrench is disclosed in U.S. Pat. No. 5,823,077, which teaches a wrench with two heads and a slidable handle. All of these wrenches, however, are fixed together and do not separate into individual components.

According to other conventional designs, different wrenches, socket wrenches, ratchet socket wrenches, or reversible ratchet socket wrenches may be used for turning different sizes of bolts and nuts, or other fastening pairs. Further, for turning bolts and nuts of different sizes, a socket wrench must be used of a full set of hexagon head sockets. When carrying socket wrench and a fill set of hexagon head sockets, a special tool box or the like must be used. It is expensive to prepare a special toolbox, different hand tools and tool accessories.

It would be an advantage to provide a hand tool that has two wrench heads, each situated at opposite distal ends of the tool and on separate handles. The handles can be locked together via a mating connection, and separated when necessary for ease of use. The hand tool provides two matching wrench tools that can be used in concert on two parts of a fastening pair.

It would a further advantage to provide a plurality of hand tools in a kit form, so that a user is able to employ one of the plurality of hand tools as described. Each hand tool, or wrench, set can be used with a fastening pair of a particular size.

### BRIEF SUMMARY OF THE INVENTION

The invention relates to a novel wrench that comprises a first handle having a first wrench head and a first neck extending from the first wrench head to a first distal end, a second handle having a second wrench head and a second neck extending from the second wrench head to a second distal end, and a mating connection formed by the first and second handles, the mating connection capable of locking the first and second handles together when the first and second ends are at opposite ends of the wrench.

The invention also relates to a kit comprising a plurality of hand tools and a package to hold the plurality of hand tools, wherein each hand tool comprises a first handle having a first wrench head and a first neck extending from the first wrench head to a first distal end, a second handle having a second wrench head and a second neck extending from the second wrench head to a second distal end, and a mating connection formed between the first and second handles, the mating connection capable of locking the first and second handles together when the first and second ends are at opposite ends of the wrench. The plurality of hand tools in the kit comprise a first hand tool having a first wrench head that is configured to fit a first part of a first fastening pair and a second wrench head that is configured to fit a second part of the first fastening pair and a second hand tool having a first wrench head that is configured to fit a first part of a second fastening pair and a second wrench head that is configured to fit a second part of the second fastening pair.

In one embodiment, the invention is a hand tool system comprising: a first handle having a first wrench head and a first neck extending from the first wrench head to a first distal end; a second handle having a second wrench head and a second neck extending from the second wrench head to a second distal end; and a mating connection formed integral with each of said handles, said mating incorporating a channel structure in said first handle and a female corresponding attaching structure in said second handle, wherein said female attaching structure is constructed and arranged to pair with said channel and releasably connect each of said first and second handles.

The first wrench head is configured to fit a first part of a fastening pair and the second wrench head is configured to fit a second part of the fastening pair.

In one embodiment, first wrench head and the second wrench head of the attached pair are the same size.

Further, the first wrench head and the second wrench head have a similar wrench head configuration.

In one embodiment, the first wrench head type is an open end wrench head and the second wrench head type is a box wrench head of a given connected pair.

The mating connection is located substantially equidistant from the first wrench head and the second wrench head.

The first wrench head type and the second wrench head type are selected from the group consisting of a an open-end wrench, a box wrench, a socket wrench, a ring spanner, a flare-nut wrench, an adjustable crescent wrench, a torque wrench, a saltus wrench, and a slogging spanner.

Alternatively, the first wrench head and the second wrench head are of different sizes.

When the wrench heads are different sizes, the wrench heads are selected from the group consisting of a an open-end wrench, a box wrench, a socket wrench, a ring spanner, a flare-nut wrench, an adjustable crescent wrench, a torque wrench, a saltus wrench, and a slogging spanner.

The present invention also encompasses a hand tool system comprising: a first handle having a first wrench head and a first neck extending from the first wrench head to a first distal end; a second handle having a second wrench head and a second neck extending from the second wrench head to a second distal end; and a mating connection formed integral with each of said handles, said mating incorporating a spring tension post on a said first handle and a receiving channel interlock on said second handle, wherein said spring tension post is constructed and arranged to pair with said receiving channel interlock on said second handle to releasably connect each of said first and second handles.

Also, the present invention is a kit comprising: a plurality of hand tools, wherein each hand tool comprises: a first handle having a first wrench head and a first neck extending from the first wrench head to a first distal end; and a mating connection formed integral with each of said handles, said mating incorporating a channel structure in said first handle and a female corresponding attaching structure in said second handle, wherein said female attaching structure is constructed and arranged to pair with said channel and releasable connect each of said first and second handles, the mating connection capable of locking the first and second handles together when the first and second ends are at opposite ends of the wrench; and a package to hold the plurality of hand tools, wherein said plurality of hand tools comprises: said first hand tool having a first wrench head that is configured to fit a first part of a first fastening pair and a second wrench head that is configured to fit a second part of the first fastening pair; and said second hand tool having a first wrench head that is configured to fit a first part of a second fastening pair and a second wrench head that is configured to fit a second part of the second fastening pair.

The kit has a first wrench head and the second wrench head of each of the hand tools are the same type.

Alternatively, the first wrench head and the second wrench head of each of the hand tools are of different sizes.

The first wrench head type and the second wrench head type of each of the hand tools are selected from the group consisting of a an open-end wrench, a box wrench, a socket wrench, a ring spanner, a flare-nut wrench, an adjustable crescent wrench, a torque wrench, a saltus wrench, and a slogging spanner.

The kit of claim 11, wherein the first wrench head and the second wrench head of each of the hand tools are different types, for example, but not limited to an open end wrench and a box wrench.

In one embodiment, the first wrench head and the second wrench head of each of the hand tools are of different sizes.

In the kit, the mating connection of each of the hand tools is located substantially equidistant from the first wrench head and the second wrench head.

In the kit, the first wrench head type and the second wrench head type of each of the hand tools are selected from the group consisting of a an open-end wrench, a box wrench, a socket wrench, a ring spanner, a flare-nut wrench, an adjustable crescent wrench, a torque wrench, a saltus wrench, and a slogging spanner.

The kit has a plurality of tools are designed for use in different project types; wherein the project types are selected from the group consisting of motorcycle repair, automotive repair, small engine repair, general home repair, and appliance repair.

Other systems, methods, features, and advantages of the present invention will be or will become apparent to one with skill in the art upon examination of the following figures, detailed description and claims. It is intended that all such additional systems, methods, features, and advantages be included within this description, be within the scope of the invention, and be protected by the accompanying claims.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a perspective view of the wrench with the first and second handles connected.

FIG. 2 is a perspective view of the wrench with the first and second handles partially separated.

FIG. 3 is another perspective view of the wrench with the first and second handles partially separated.

FIG. 4 is a perspective view of the wrench with the first and second handles completely separated.

FIG. 5 another view of the wrench in use with the first and second handles connected.

FIG. 6 is a side elevational view of the wrench in use with the first and second handles connected.

FIG. 7 is a top view of the wrench with the first and second handles connected.

FIGS. 8A-8I depict illustrations of different types of wrench heads that can be included on the first and second handles.

FIGS. 9A-9E depict illustrations of different types of mating connections that can be used to lock the handles together.

FIG. 10 is an illustration of a plurality of wrenches in a first kit format.

FIGS. 11A-11B are two illustrations of a plurality of wrenches in a second kit format.

FIG. 12 depicts an illustration of the wrench in use on a fastening pair of a tire.

FIG. 13 is an isometric of the wrench assembly according to one embodiment of the present invention.

FIG. 14 is an isometric of a box and wrench according to one embodiment of the present invention.

FIG. 15 is an isometric of an open end wrench according to one embodiment of the present invention.

FIG. 16 is a detail of open end wrench with a locking mechanism according to the present invention.

FIG. 17 is a box end wrench with a locking mechanism according to the present invention.

FIG. 18 is an assembly of box and open end wrenches with a connection according to the present invention.

FIG. 19 is a cross section from A-A of FIG. 18 taken through a ball detent mechanism according to the present invention.

FIG. 20 is a cross section along B-B of FIG. 18 taken through the post and key slot mechanism according to the present invention.

FIG. 21 is an assembly of a box and open end wrench with a channel lock connecting means according to the present invention.

FIG. 22 is a cross section along lines D-D taken through ball detent mechanism according to the present invention.

FIG. 23a is a cross section along lines C-C taken through the sliding channel mechanism according to the present invention.

FIG. 23b is a separated portion from FIG. 23a of the female connecting portion of channel connection from FIG. 21.

FIG. 23c is a separated view from FIG. 23a showing the female receiving channel portion whereby FIGS. 23b and 23c interlock when they are connected.

FIG. 24 is an assembly of the present invention whereby 2 wrench bodies, each with a single wrench head are connected by a screw and receiving screw thread connection.

FIG. 25 is a separated wrench from the assembly of FIG. 24 with a single wrench head showing a threaded portion.

FIG. 26 is a separated wrench from the assembly of FIG. 24 with a single wrench head showing a threaded portion and a cross section showing an internal cavity whereby a portion of the wrench from FIG. 25 is placed therein as indicated by the arrows.

### DETAILED DESCRIPTION OF THE INVENTION

The invention relates to a novel wrench that comprises a first handle having a first wrench head and a first neck extending from the first wrench head to a first distal end, a second handle having a second wrench head and a second neck extending from the second wrench head to a second distal end, and a mating connection formed by the first and second handles, the mating connection capable of locking the first and second handles together when the first and second ends are at opposite ends of the wrench.

The invention also relates to a kit comprising a plurality of hand tools and a package to hold the plurality of hand tools, wherein each hand tool comprises a first handle having a first wrench head and a first neck extending from the first wrench head to a first distal end, a second handle having a second wrench head and a second neck extending from the second wrench head to a second distal end, and a mating connection formed between the first and second handles, the mating connection capable of locking the first and second handles together when the first and second ends are at opposite ends of the wrench. The plurality of hand tools in the kit comprise a first hand tool having a first wrench head that is configured to fit a first part of a first fastening pair and a second wrench head that is configured to fit a second part of the first fastening pair and a second hand tool having a first wrench head that is configured to fit a first part of a second fastening pair and a second wrench head that is configured to fit a second part of the second fastening pair.

In many repair instances it is desirable to have a tool set wherein wrench heads are matched for use on a fastening pair.

The fastening pair may require complementary wrench heads in order to easily and efficiently tighten or loosen the parts of the pair. For example, a nut and bolt fastening pair can be found on either side of a motorcycle or bicycle tire. The nut would necessitate the use of an open head wrench, while the bolt would necessitate the use of a box wrench. Frequently, it can be difficult to keep track of wrench sets, particularly pairs of wrenches intended to be used together for tightening and/or loosening the parts of a fastening pair.

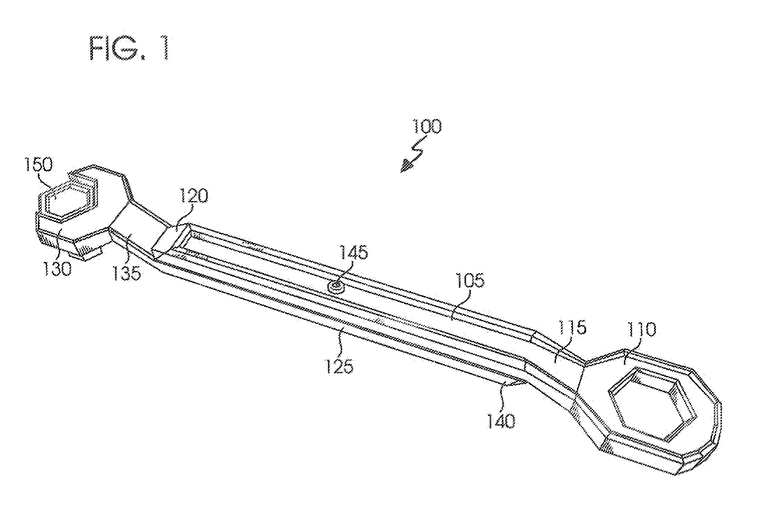

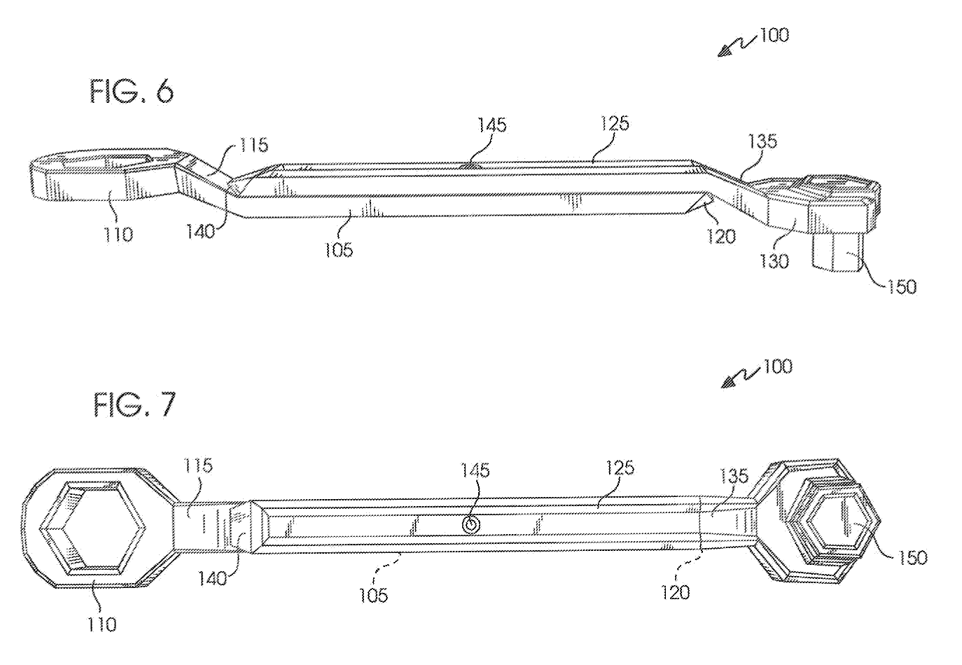

As seen in FIGS. 1-7, the hand tool 100 comprises a first handle 105 having a first wrench head 110 and a first neck 115 extending from the first wrench head 110 to a first distal end 120, a second handle 125 having a second wrench head 130 and a second neck 135 extending from the second wrench head 130 to a second distal end 140, and a mating connection 145 formed by the first and second handles, 105, 125. The mating connection 145 being capable of locking the first and second handles 105, 125 together when the first and second ends 120, 140 are at opposite ends of the hand tool 100.

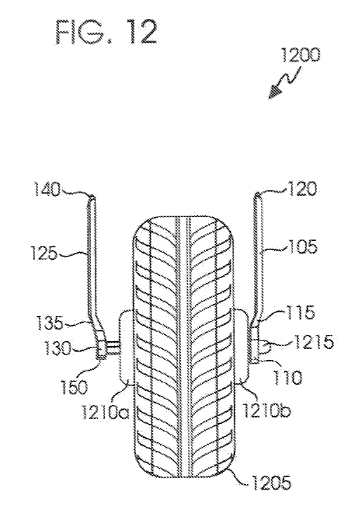

In FIGS. 1, 2, 4-7, and 12 the second wrench head 130 is being used to tighten or loosen a bolt 150. The bolt 150 may be one of the two elements of a fastening pair, the other element of the fastening pair may be a nut 1215 (as seen in FIG. 12). Other fastening pairs may include a threaded axle and two nuts (such as found in bicycle and motorcycle axles).

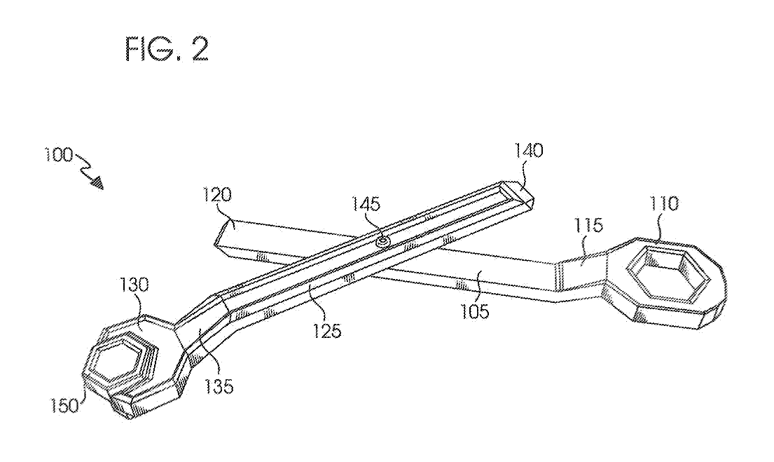

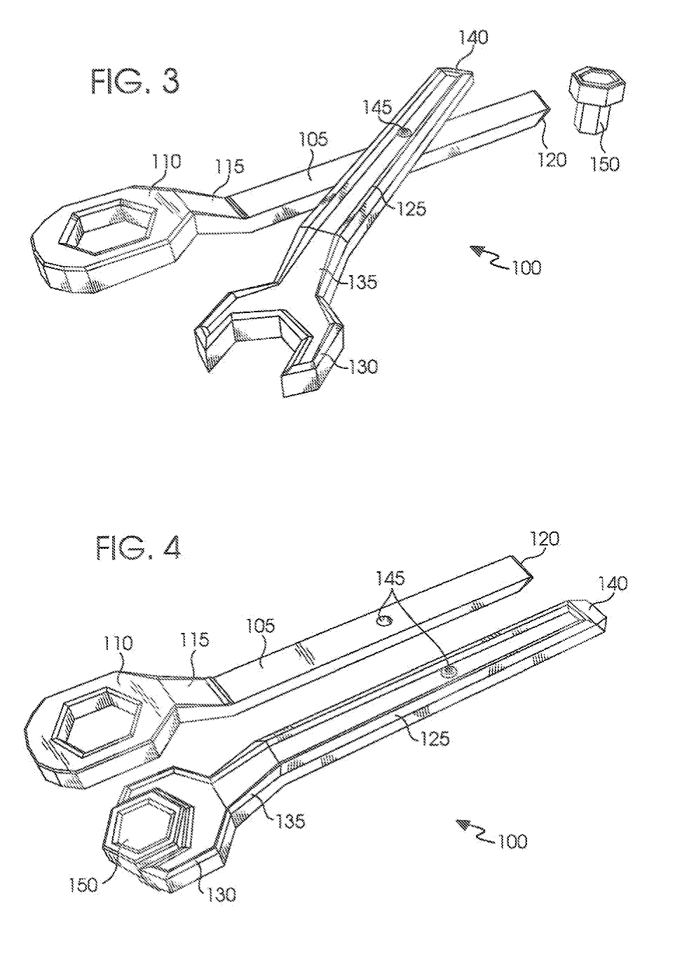

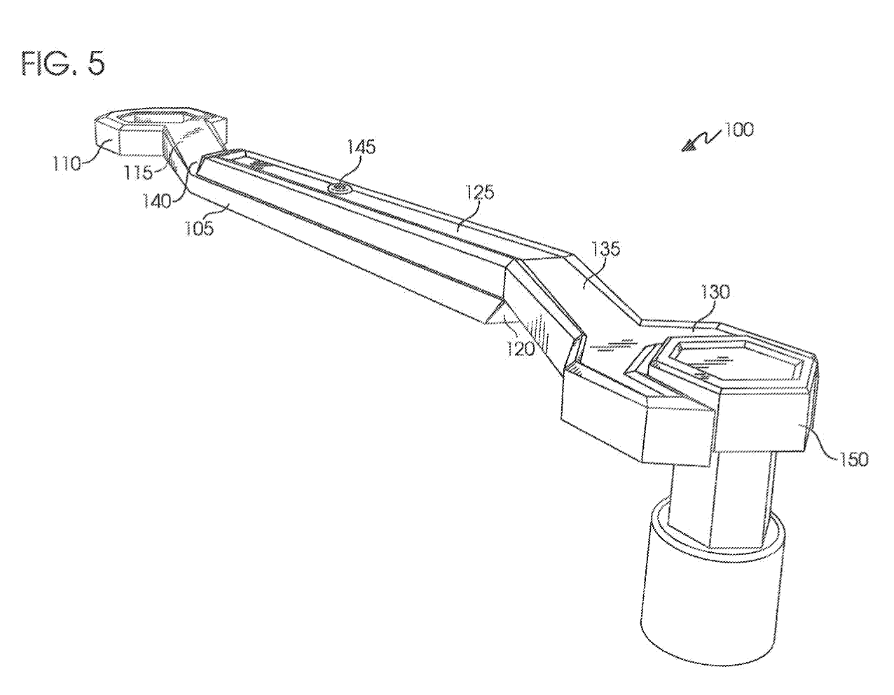

FIG. 1 is an illustration of the hand tool 100 in a locked position. FIGS. 2 and 3 illustrate the wrench 100 in two partially open states. FIG. 4 illustrates the two portions of the wrench 100 in an unlocked and separate state. FIGS. 5-7 show the wrench 100 in a locked configuration.

In general, the hand tool 100 may have the first wrench head 110 and the second wrench head 130 being of the same type. Alternatively, the first wrench head 110 and the second wrench head 130 may be of different types. In one preferred embodiment, the first wrench head 110 is an open end wrench head and the second wrench head 130 is a box wrench head.

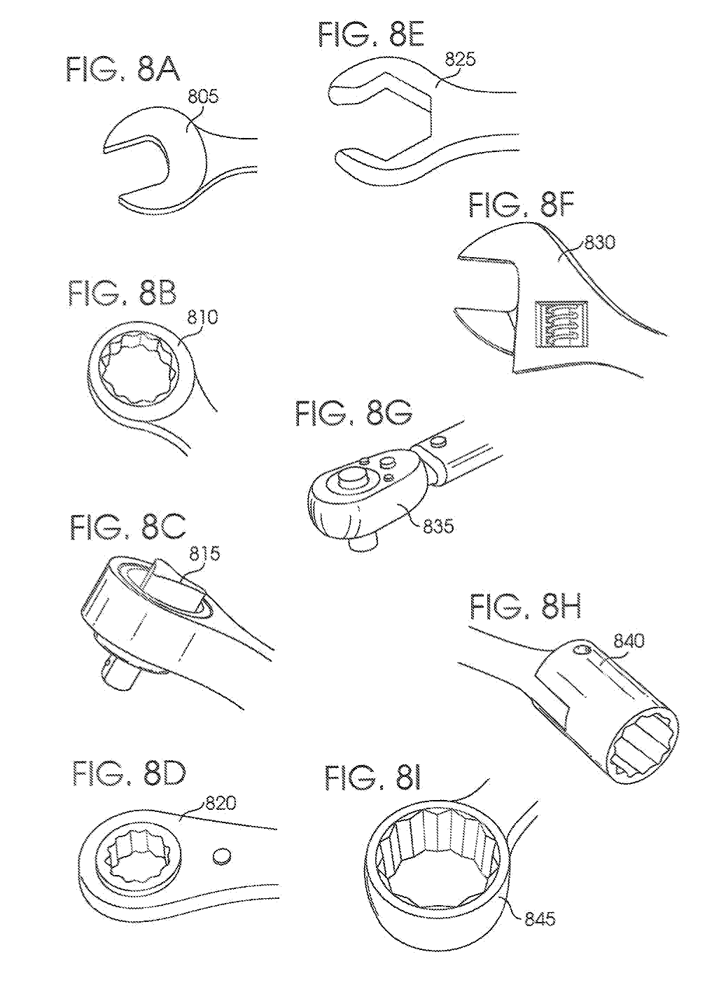

In other embodiments, the first wrench head 110 and the second wrench head 130 may be, but is not limited to, an open-end wrench 805, a box wrench 810, a socket wrench 815, a ring spanner 820, a flare-nut wrench 825, an adjustable crescent wrench 830, a torque wrench 835, a saltus wrench 840, and a slogging spanner 845. These wrench head types are shown in FIGS. 8A-8I. Moreover, the first and second wrench heads may be of the same or different sizes. In this regard size refers to the internal diameter of each wrench head 110 and 130, which may be measured the metric, standard or any other measurement format.

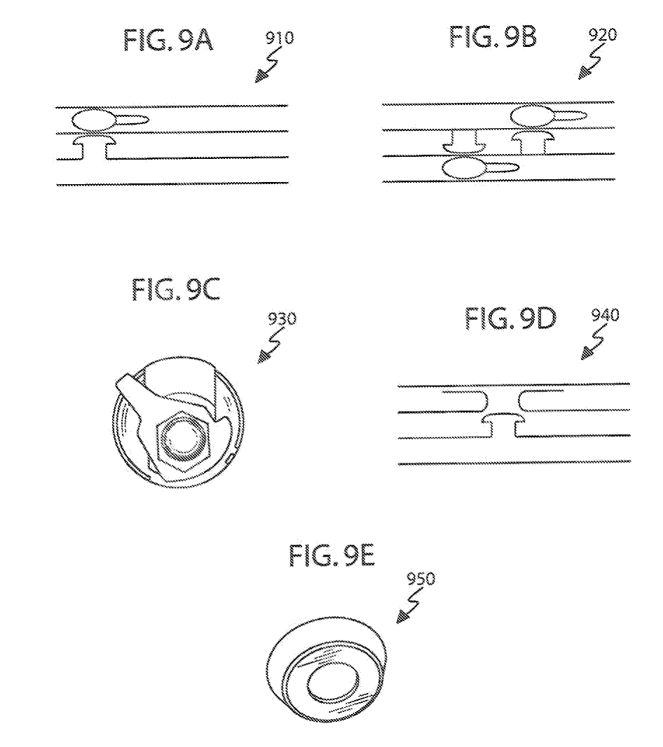

The mating connection 145 may be located substantially equidistant from the first wrench head 110 and the second wrench head 130. The mating connection may be, but is not limited to, a single figure eight lock 910, a dual figure eight lock 920, a cam and pin lock 930, a deformable lock 940, and a magnetic lock 950, as shown in FIGS. 9A-9E.

The hand tool 100 may be employed in a wide variety of projects and repairs. The projects may include, but are not limited to, motorcycle repair, automotive repair, small engine repair, general home repair, and appliance repair. Accordingly, it is contemplated that the hand tool 100 will be sold in kits containing a plurality of hand tools (e.g., 100a, 100b, 100c, 100n) in various sizes with all of the tools included in a particular kit being clustered around the types of fasteners and fastening pairs that would be encountered during a particular type of project. For instance, the kit could include the particular types of wrench heads and sizes useful in repairing bicycles in general, but could also be focused on a particular type of bicycle (e.g., utility, mountain, racing, touring, etc.). In another for instance, a kit could include the particular types of wrench heads and sizes useful in repairing motorcycles in general, but could also be focused on a particular manufacturer and/or type.

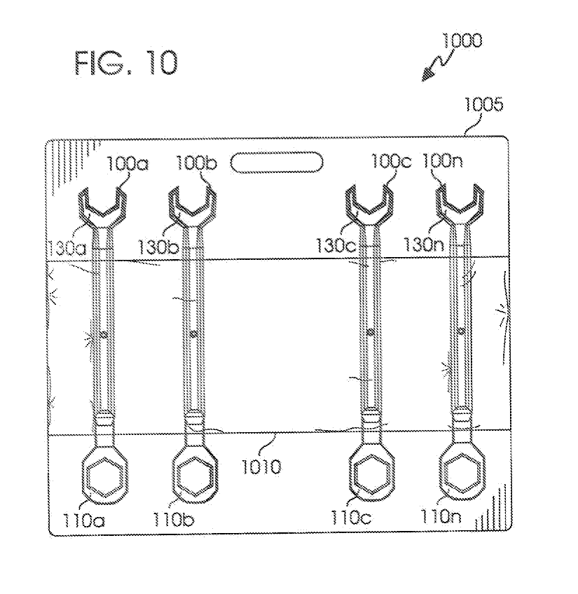

One such kit 1000 is depicted in FIG. 10 as having a plurality of wrenches attached to a backing 1005 via a blister pack 1010. The hand tools, or wrenches 100a, 100b, 100c, 100n are depicted in this illustration as having a first wrench head 110a, 110b, 110c, 110n that is a box wrench head. The second wrench head 130a, 130b, 130c, 130n is an open wrench head. Of course, this selection is merely for purposes of illustration it being understood that depending upon the type of project the kit was intended to address, a variety of tool types will likely be included. Moreover, it is contemplated that the kits may include tools and other desirable things that do not incorporate the novel hand tool design.

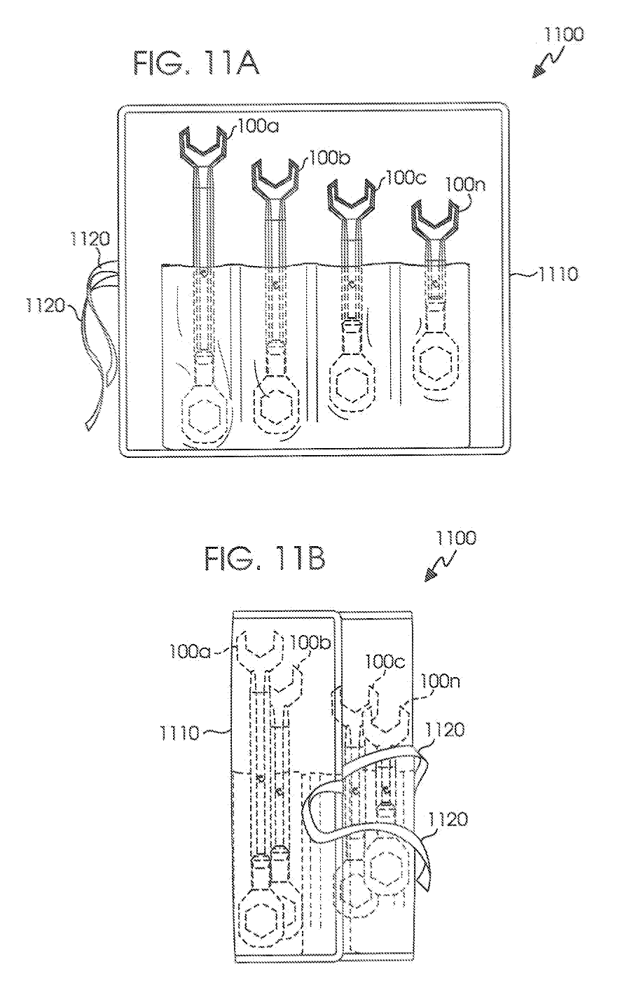

FIGS. 11A-11B depict a second kit embodiment in an open form and a closed form. Here, the plurality of wrenches 100a, 100b, 100c, 100n are fit into the pouch 1110 of a cloth holder 1100. FIG. 11 A shows the kit open, so that the wrenches 100a, 100b, 100c, 100n may be easily accessed. FIG. 11B shows the kit, wherein the cloth holder 1100 is rolled up for storage or between uses. As in FIG. 9, the hand tools, or wrenches 100a, 100b, 100c, 100n are depicted in this illustration as having a first wrench head 110a, 110b, 110c, 110n that is a box wrench head. The second wrench head 130a, 130b, 130c, 130n is an open wrench head. The cloth holder may be secured by ties 1120.

FIG. 12 illustrates the use of the wrench 100 for performing repair on a tire 1205. Specifically, on a first side of a tire 1205, the first wrench head 100, which here is a box wrench head, is used to tighten or loosen a nut 1215. The nut 1215 is a first part of a fastening pair. On the opposite side of the tire 1205, the second wrench head 130 is used for tightening and loosening the bolt 150, which is the second part of a fastening pair. The type of use--with opposing nuts needing to be counter-biased—is the ideal job for the hand tool 100, but other tasks are made easier.

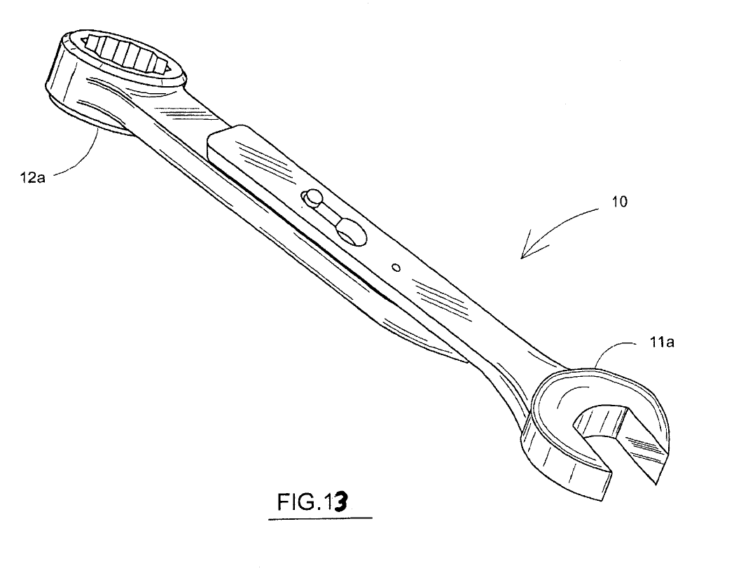

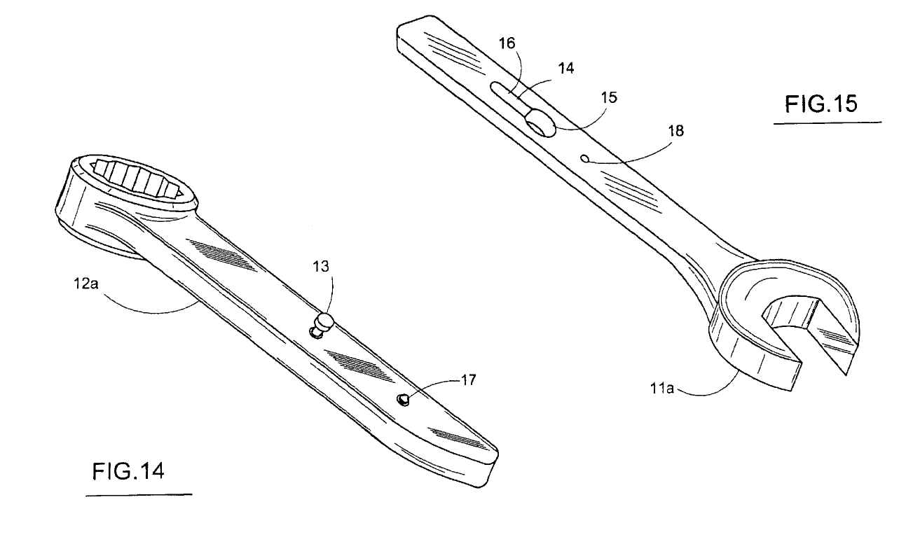

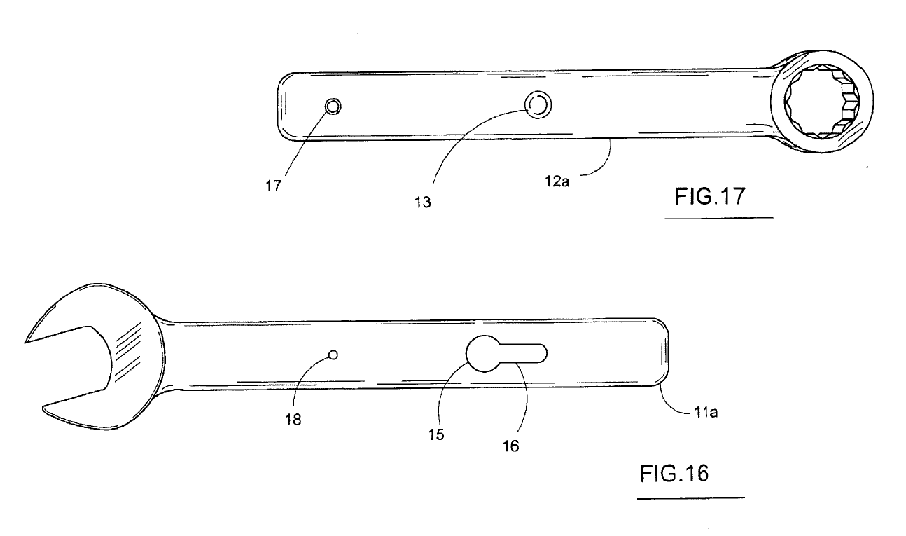

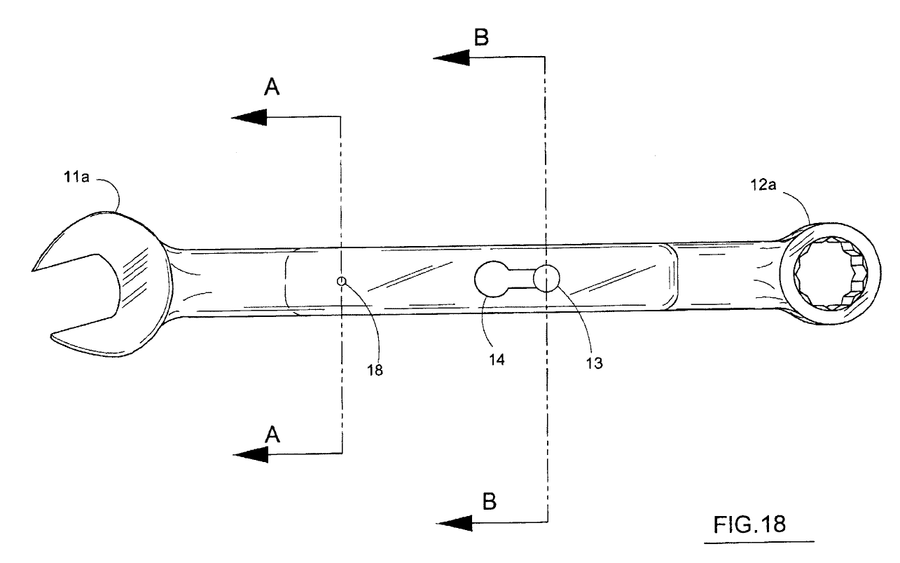

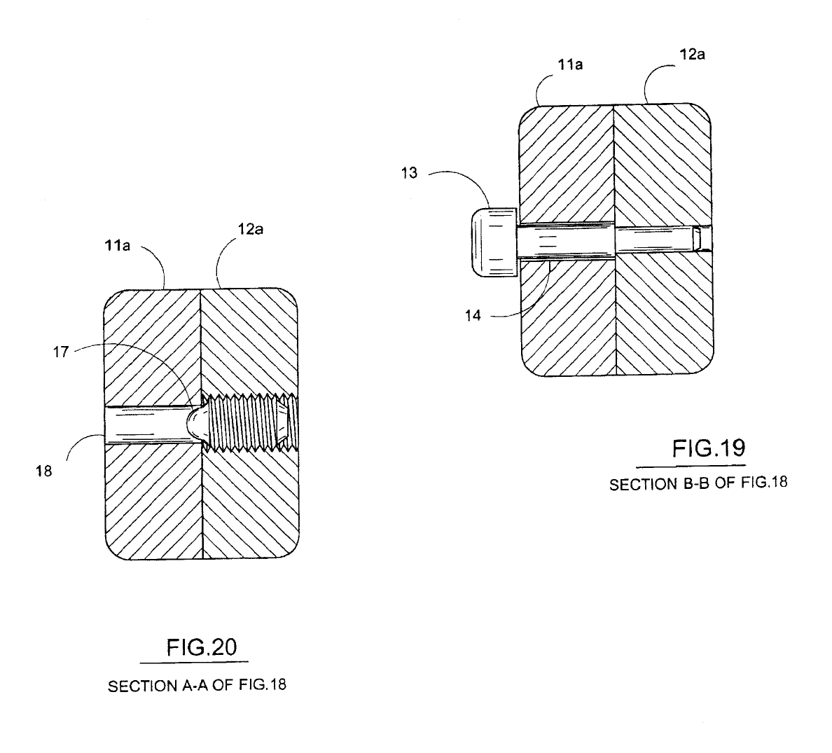

In another embodiment as shown in FIGS. 13-17 wrench 10 has attaching post 13 and ball detent spring loaded plunger 17. Wrench 13 is constructed and arranged to interact with channel 16 that has incorporated thereon connecting cavity 15. When each wrench is connected attaching post 13 is inserted through receiving cavity 15. Receiving cavity 15 is constructed and arranged such that it is larger than the upper most portion of connecting post 13. Connecting post 13 is then moved along connecting cavity 14 and terminating at the end of connecting cavity at point 16. This arrangement interlocks the two wrenches into a single unit. Ball detent 17 is constructed and arranged to correspond with receptacle indentation 18 such that an internal spring (not shown) urges upward on attaching post 13 such that pressure assists in the interlocking of the two wrenches. FIG. 19 being a cross section A-A from FIG. 18 shows the interconnecting of receptacle indentation 18 with ball detent spring loaded plunger 17.

In use, said post 13 is passed though the corresponding connection cavity and slidably moved into position through receiving cavity 15. The corresponding receptacle indentation 18 mates with ball detent 17 to stop said slidable motion and secure said wrenches one to another.

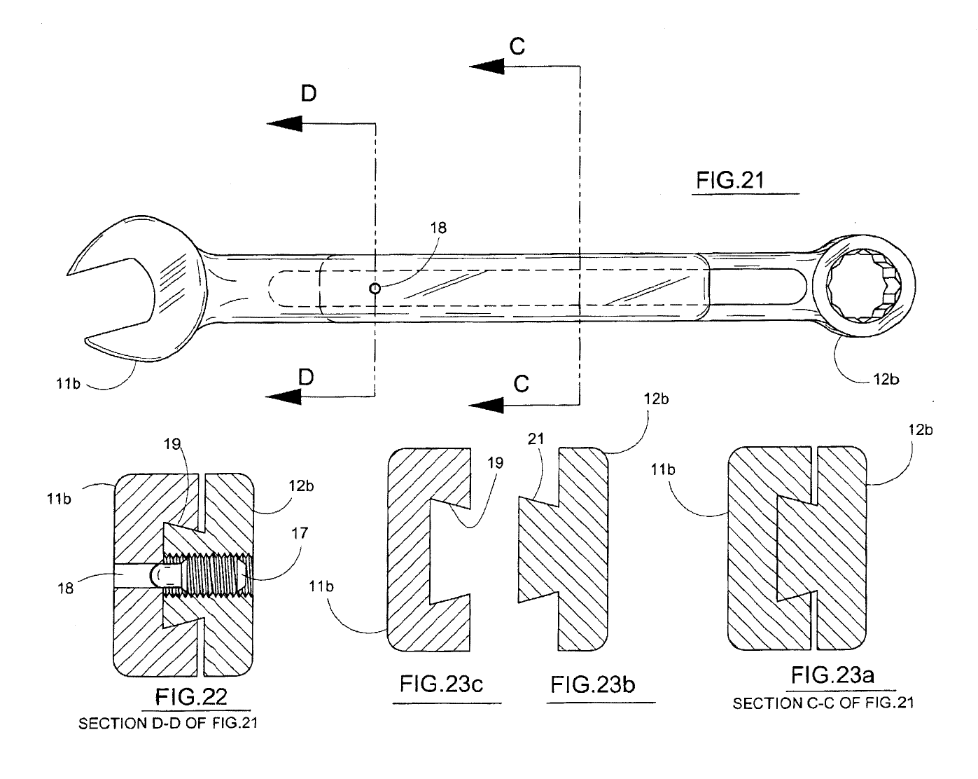

In another embodiment, as shown in FIGS. 21-24, each wrench is constructed and arranged along its length along with a male/female channel interlock system. Male channel interlock 19 incorporated onto surface 12B. In this embodiment a similar spring loaded plunger and receptacle hole system as previously described work in concert to secure the wrenches once the channel interlock is connected. In this embodiment an incorporated channel 19 receives female channel interlock 21 and a slidable attachment along channel 19 is performed. Receptacle indentation 18 mates with ball detent 17 to stop said slidable motion and secure said wrenches one to another.

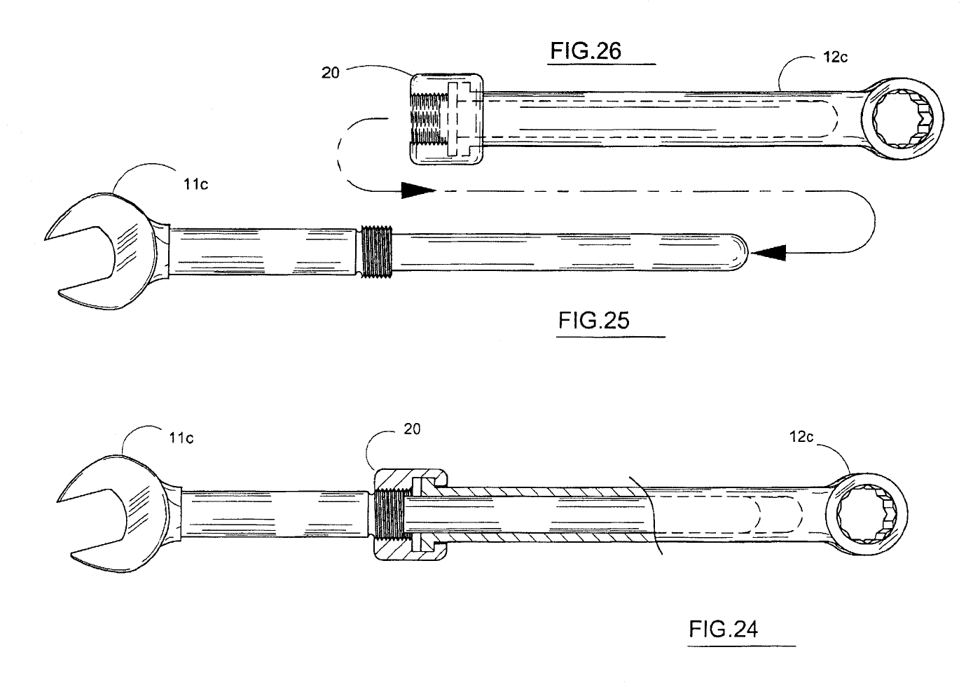

AS shown in FIGS. 24-26, wrench body 12c has a threaded receiver 20 constructed and arranged for a screw-type attachment of screw threads from wrench 11c. Wrench 12c further has an internal cavity, as shown in the cross section of FIG. 26, to receive a portion of wrench 11c when the screw interconnection is formed.

The kit of the present invention incorporates a set of wrenches each with a single attachment means. That is to say, all detachable wrench pairs attach and detach by the same means.

In one embodiment, the wrench pairs are matched one to another, but different pairs have different attachment means.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit.

I claim:

1. A hand tool system comprising: a first handle having a first wrench head and a first neck extending from the first wrench head to a first distal end; a second handle having a second wrench head and a second neck extending from the second wrench head to a second distal end; and a mating connection formed integral with each of said handles.

2. The hand tool of claim 1, wherein said mating includes incorporating a channel structure in said first handle and a female corresponding attaching structure in said second handle, wherein said female attaching structure is constructed and arranged to pair with said channel and releasably connect each of said first and second handles.

3. The hand tool of claim 2, wherein the first wrench head and the second wrench head are the same size.

4. The hand tool of claim 2, wherein the first wrench head and the second wrench head have a similar wrench head configuration.

5. The hand tool of claim 4, wherein the first wrench head type is an open end wrench head and the second wrench head type is a box wrench head.

6. The hand tool of claim 5, wherein the mating connection is located substantially equidistant from the first wrench head and the second wrench head.

7. The hand tool of claim 4, wherein the first wrench head type and the second wrench head type are selected from the group consisting of a an open-end wrench, a box wrench, a socket wrench, a ring spanner, a flare-nut wrench, an adjustable crescent wrench, a torque wrench, a saltus wrench, and a slogging spanner.

8. The hand tool of claim 4, wherein the first wrench head and the second wrench head are of different sizes.

9. The hand tool of claim 8, wherein the first wrench head type and the second wrench head type are selected from the group consisting of a an open-end wrench, a box wrench, a socket wrench, a ring spanner, a flare-nut wrench, an adjustable crescent wrench, a torque wrench, a saltus wrench, and a slogging spanner.

10. A hand tool system comprising: a first handle having a first wrench head and a first neck extending from the first wrench head to a first distal end; a second handle having a second wrench head and a second neck extending from the second wrench head to a second distal end; and a mating connection formed integral with each of said handles, said mating incorporating a spring tension post on a said first handle and a receiving channel interlock on said second handle, wherein said spring tension post is constructed and arranged to pair with said receiving channel interlock on said second handle to releasably connect each of said first and second handles.

11. A kit comprising: a plurality of hand tools, wherein each hand tool comprises: a first handle having a first wrench head and a first neck extending from the first wrench head to a first distal end; and a mating connection formed integral with each of said handles, said mating incorporating a channel structure in said first handle and a female corresponding attaching structure in said second handle, wherein said female attaching structure is constructed and arranged to pair with said channel and releasable connect each of said first and second handles, the mating connection capable of locking the first and second handles together when the first and second ends are at opposite ends of the wrench; and a package to hold the plurality of hand tools, wherein said plurality of hand tools comprises: said first hand tool having a first wrench head that is configured to fit a first part of a first fastening pair and a second wrench head that is configured to fit a second part of the first fastening pair; and said second hand tool having a first wrench head that is configured to fit a first part of a second fastening pair and a second wrench head that is configured to fit a second part of the second fastening pair.

12. The kit of claim 11, wherein the first wrench head and the second wrench head of each of the hand tools are the same type.

13. The kit of claim 12, wherein the first wrench head and the second wrench head of each of the hand tools are of different sizes.

14. The kit of claim 13 wherein the first wrench head type and the second wrench head type of each of the hand tools are selected from the group consisting of a an open-end wrench, a box wrench, a socket wrench, a ring spanner, a flare-nut wrench, an adjustable crescent wrench, a torque wrench, a saltus wrench, and a slogging spanner.

15. The kit of claim 11, wherein the first wrench head and the second wrench head of each of the hand tools are different types.

16. The kit of claim 15, wherein the first wrench head and the second wrench head of each of the hand tools are of different sizes.

17. The kit of claim 15, wherein the mating connection of each of the hand tools is located substantially equidistant from the first wrench head and the second wrench head.

18. The kit of claim 15, wherein the first wrench head type and the second wrench head type of each of the hand tools are selected from the group consisting of a an open-end wrench, a box wrench, a socket wrench, a ring spanner, a flare-nut wrench, an adjustable crescent wrench, a torque wrench, a saltus wrench, and a slogging spanner.

19. The kit of claim 11, wherein the plurality of tools are designed for use in different project types; wherein the project types are selected from the group consisting of motorcycle repair, automotive repair, small engine repair, general home repair, and appliance repair.
